(19) United States
(12) Patent Application Publication
(10) Pub. No.: US 2022/0058596 A1
(43) Pub. Date: Feb. 24, 2022

(54) Pyramidion Cryptocurrency

(71) Applicant: Damon D. Danner, Baton Rouge, LA (US)

(72) Inventor: Damon D. Danner, Baton Rouge, LA (US)

(21) Appl. No.: 17/407,064

(22) Filed: Aug. 19, 2021

Related U.S. Application Data
(60) Provisional application No. 63/067,747, filed on Aug. 19, 2020.
(60) Provisional application No. 63/143,655, filed on Jan. 29, 2021.

(51) Int. Cl. G06Q 20/06; G06Q 20/36; G06Q 20/38

(52) U.S. Cl. CPC G06Q 20/065; G06Q 20/363; G06Q 20/381; G06Q 20/3827; G06Q 20/3825

(57) ABSTRACT

An innovated method provides a unique cryptocurrency that is created on the blockchain using smart contract and is not backed by any fiat currency, resource, asset, or collateral. After acquiring prices of a predetermined number of cryptocurrencies of a specific exchange or all cryptocurrencies of all existing exchanges, the method calculates the average and assigns it to the cryptocurrency as a barter credit. Additionally, the method updates the barter credit of the cryptocurrency in a predetermined time interval. Further, the method facilitates a purchase process for the user to have a desired amount in the digital wallet for use in any barter exchange. The method facilities a decentralized, transparent, secure, and market driven digital medium of exchange with substantially low volatility and provides an efficient digital media for transactions, trading, and store of values on various cryptocurrency exchanges and countries, thus, offering security, trust, efficiency, and access to global economies.

The current application claims a priority to the U.S. Provisional Patent application Ser. No. 63/067,747 filed on Aug. 19, 2020.

### FIELD OF THE INVENTION

The present invention relates generally to the field of cryptocurrency. More specifically, the present invention relates to a method that provides a unique cryptocurrency that reaches consensus on a barter credit by taking the average value of all cryptocurrencies traded on a cryptocurrency exchange and assigning the average to the cryptocurrency of the present invention,

### BACKGROUND OF THE INVENTION

A cryptocurrency is a digital or virtual currency that uses strong cryptography to secure all transactions, control the creation of additional units and verify each financial ledger. Unlike traditional centralized electronic monetary and banking systems, the cryptocurrency system utilizes decentralized control through a technology known as blockchain, a distributed ledger enforced by a disparate network of computers. The first blockchain-based cryptocurrency was Bitcoin, which still remains the most popular and most valuable. Today, there are thousands of alternate cryptocurrencies with various functions or specifications. Cryptocurrencies have become a global phenomenon. According to a published study by the University of Cambridge, the combined market value of all crypto currencies was in excess of $150 billion in September 2017.

Cryptocurrencies are not controlled by a central government or authority, and most regions do not accept them as legal tender. Generally, cryptocurrencies are generated by computers, have a fixed supply, can be used as a digital medium of exchange to buy products and services, and have a relative store of value. The cryptocurrency market is still considered very new and, beyond hearing the term “cryptocurrency,” most people are still very much unfamiliar with the industry. The US senator, Thomas Carper once said, “Virtual currencies, perhaps most notably Bitcoin, have captured the imagination of some, struck fear among others, and confused the heck out of the rest of us.” As one of the nascent markets, the cryptocurrency is inherently volatile. Daily cryptocurrency trading volumes are around the $14 billion mark, while daily forex trades are close to $5 trillion. The spread, the difference between the buy and sell price, on foreign currency trades will be a few pennies, while spreads on cryptocurrency trades can be as high as a few dollars. All this points to a very thin market that naturally moves very quickly and thus increases the volatility of cryptocurrency prices. A large number of new adopters are also joining the market every single day. At the beginning of 2018, cryptocurrency exchanges reported that they were adding 100,000 new users every day. Many of these members will have significant vested interest in the price of cryptocurrencies going either up or down, which adds to the disruptive nature of the market and further increases volatility. Supply and demand have the most impact on cryptocurrency prices. If a cryptocurrency has a high token supply with little demand from traders and users, then the cryptocurrency's value will drop. Conversely, if the supply of a cryptocurrency is limited and the demand is high, then the value of the coin will increase. This is linked to the scarcity element that drives up prices and is one of the factors that saw the price of Bitcoin climb to its highest levels at the end of 2017. The supply of Bitcoin is capped at 21 million BTC (unit of account of Bitcoin), which is relatively low compared to other tokens while the demand has soared in recent years. The media or public sentiment also has a big influence over the price of cryptocurrencies. If a token or platform of a cryptocurrency gets any negative publicity, the price of that coin generally takes a dip. While, if the same coin were to get high profile support and good media coverage, the price would almost certainly increase. Thus, prices are heavily influenced by human emotions and hypes. Other factors that have significant influences on the price include the level of token utility, i.e., how useful is the token and the underlying blockchain platform in solving a real-world problem.

The volatility associated with Bitcoin and other digital currencies is one of the biggest barriers facing the widespread adoption of cryptocurrencies today. Price volatility is risk and some risk may be good since volatility allows traders to greatly profit when the opportunity is ripe. However, the problem rises when there is too much volatility and risk relative to their intended uses. Many users such as consumers and organizations intend to use cryptocurrencies as a new transaction method and others use them as a store of value. If the volatility of the price is too high, it is difficult for either of these uses to be accomplished. Most cryptocurrencies such as Bitcoin cannot be a medium of exchange because they cannot be used in transactions, particularly retail transactions with the current high volatility. The price volatility significantly diminishes the usefulness as a reliable unit of account or an effective means of payment for most cryptocurrencies in the market.

In an attempt to address the volatility associated with cryptocurrencies, “stable coins” have entered the cryptocurrency market. A stable coin is a cryptocurrency that is pegged to the value of an underlying asset, such as fiat currencies like the U.S. dollar, or financial assets like real estate. This design ensures that the value of a stable coin remains consistent, differentiating itself from other volatile cryptocurrencies. However, when a cryptocurrency targets a specific price, maintaining the targeted price, may be difficult and thus the peg may be broken. An example of stable asset is gold and the stability of gold is determined by market forces and perceived stability of the global financial system. Another example is US dollar. Stability of the dollar or gold does not come from targeting a specific price. The US dollar is relatively stable compared to many other currencies because it powers the US economy, a big and stable economy. Gold is stable because it has a perceived value and that perception has been around for millennia. Cryptocurrencies backed by fiat currencies, for example, Tether and TrueUSD are specifically used not because of their stability, but as a US dollar substitute by many cryptocurrency exchanges. As any asset-backed token, dollar backed currency is as stable as the dollar itself, as long as the relationship between the underlying asset and the token is transparent and safe. However, the shortcomings of the dollar backed tokens are obvious. Specifically, the coin's ecosystem must be plugged into a traditional banking system to hold the underlying fiat currency at best with a centralized custodian, of which the arrangement and total amount may not be transparent.

Thus, it is the objective of the present invention to provide a solution to the constant high volatility of cryptocurrencies.

### SUMMARY OF THE INVENTION

The present invention offers a new type of cryptocurrency that is not backed by any fiat currency, resource, asset, or collateral such as real estate. The cryptocurrency of the present invention is created on blockchain using smart contract and reaches consensus on a barter credit by taking the average value of all cryptocurrencies traded on a specific cryptocurrency exchange or all existing exchanges. Additionally, the present invention is a decentralized, transparent, secure, and market driven digital medium of exchange with substantially lower volatility than any of the underlying cryptocurrencies. The embodiments of the present invention can be used as efficient media of exchange for transactions, trading, and store of values. Furthermore, the present invention offers security, trust, efficiency, and access to global economies.

The method of the present invention provides and facilitates this unique type of cryptocurrency that can be used in any barter exchange transactions. The method acquires prices of a predetermined number of cryptocurrencies of a specific exchange or all cryptocurrencies of all existing exchanges. After removing invalid prices, the method calculates the average of the acquired prices and assigns it to the Pyramidion cryptocurrency of the present invention as a barter credit. The averaging method may include, but is not limited to, simple arithmetic averaging, price weighted averaging, or volume weighted averaging, etc. Additionally, the method conducts price acquisition, average calculation, and updating the price of the Pyramidion cryptocurrency in a predetermined time interval to update a user with the most recent barter credit of the Pyramidion cryptocurrency. Further, the method facilitates the purchase process with the user so that the use may have desired amount of barter credits of the Pyramidion cryptocurrency in the user's specified digital wallet to use in any barter exchange transactions.

### BRIEF DESCRIPTION OF THE DRAWINGS

FIG. 1 is a system diagram of the present invention.

FIG. 2 is a flowchart for the overall process followed by the method of the present invention.

FIG. 3 is a flowchart for a sub-process for acquiring cryptocurrency prices of the method of the present invention.

FIG. 4 is a flowchart for an alternative embodiment of the sub-process for acquiring cryptocurrency prices of the method of the present invention, wherein the method acquires the prices of all cryptocurrencies traded on all exchanges.

FIG. 5 is a flowchart for a sub-process for assigning barter credit to the Pyramidion cryptocurrency of the method of the present invention.

FIG. 6 is a flowchart for an alternative embodiment of the sub-process for assigning barter credit to the Pyramidion cryptocurrency of the method of the present invention, wherein the method uses a price weighted averaging method.

FIG. 7 is a flowchart for another embodiment of the sub-process for assigning barter credit to the Pyramidion cryptocurrency of the method of the present invention, wherein the method uses a volume weighted averaging method.

FIG. 8 is a flowchart for a sub-process for facilitating a purchase of the Pyramidion cryptocurrency of the method of the present invention.

### DETAIL DESCRIPTIONS OF THE INVENTION

All illustrations of the drawings are for the purpose of describing selected versions of the present invention and are not intended to limit the scope of the present invention.

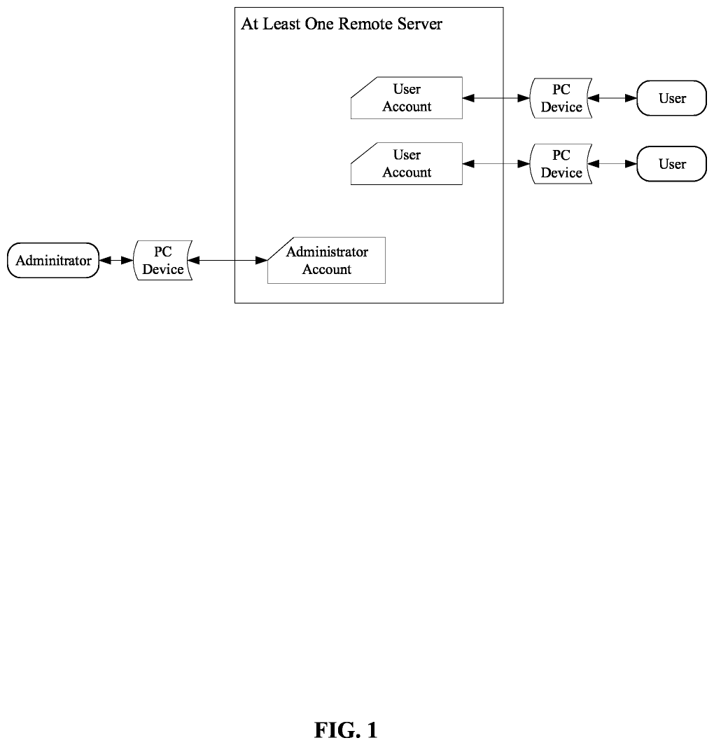

As can be seen in FIG. 1 to FIG. 8, the present invention, named Pyramidion Cryptocurrency hereafter and exchangeable with Pyra and/or PYRA, is a method for providing and facilitating a unique type of cryptocurrency that is not backed by any fiat currency, gold, resource, asset, or collateral such as real estate. The Pyramidion Cryptocurrency of the present invention is created on the blockchain using smart contract and reaches consensus on a barter credit at the average price of all cryptocurrencies traded on a specific cryptocurrency exchange or all existing cryptocurrency exchanges. Like most cryptocurrencies, the present invention is a decentralized, transparent, secure, and market driven digital medium of exchange with substantially lower volatility than any of the underlying cryptocurrencies. The embodiments of the present invention on various cryptocurrency exchanges and countries can be used as efficient media of exchange for transactions, trading, and store of values. Furthermore, the present invention offers users security, trust, transparency, market-driven efficiency, and access to global economies.

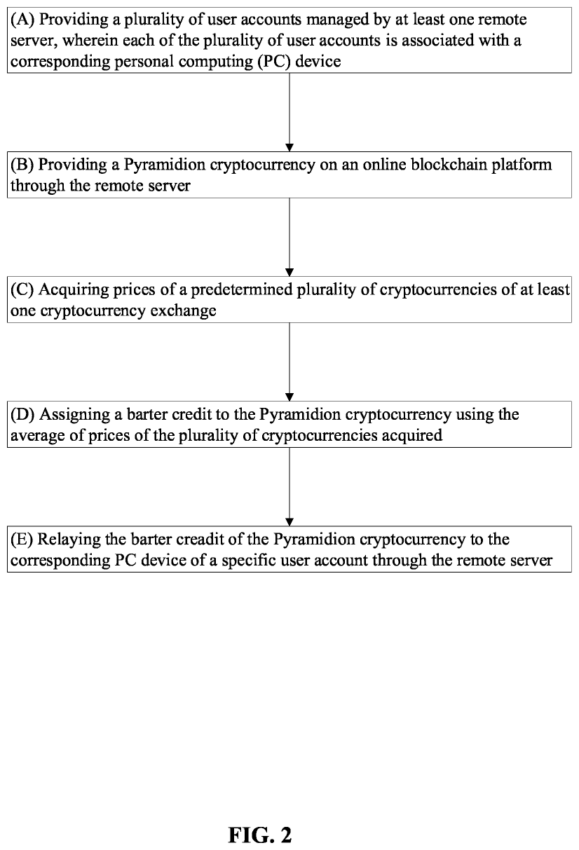

As can be seen in FIG. 1 to FIG. 2, the present invention provides an innovative method to the Pyramidion cryptocurrency to a user. To accomplish this, the method of the present invention associates each of the plurality of users with a unique user account from a plurality of user accounts that are managed by at least one remote server (Step A). Each of the plurality of user accounts is associated with a corresponding personal computing (PC) device. The corresponding PC device allows a user to interact with the present invention and can be, but is not limited to, a smartphone, a smart watch, a cloud PC, a laptop, a desktop, a server, a terminal PC, or a tablet PC, etc. The users of the user accounts may include relevant parties such as, but are not limited to, individuals, professionals, managers, business owners, consumers, companies, corporations, associations, government entities, banks, financial centers, digital banks, digital currency exchanges, cryptocurrency exchanges, administrators, etc. Further, the at least one remote server is used to manage the medical treatment analysis platform for the plurality of user accounts. The remote server can be managed through an administrator account by an administrator as seen in FIG. 1. The administrator who manages the remote server includes, but is not limited to, owner, office manager, technician, engineer, system engineer, system specialist, software engineer, information technology (IT) engineer, IT professional, IT manager, IT consultant, service desk professional, service desk manager, consultant, manager, executive officer, chief operating officer, chief technology officer, chief executive officer, president, company, corporation, organization, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, cloud applications, and mobile applications compatible with a corresponding user PC device. Additionally, the software processes may store data into internal databases and communicate with external databases, which may include, but are not limited to digital currency databases, cryptocurrency databases, cryptocurrency exchange databases, databases maintaining data about cryptocurrency prices and/or trading volumes, etc. The interaction with external databases over a communication network may include, but is not limited to, the Internet.

As can be seen in FIG. 2, the overall process of the method of the present invention provides the Pyramidion cryptocurrency on an online blockchain platform through the remote server (Step B). More specifically, in the preferred embodiment of the present invention, the method provides the Pyramidion Cryptocurrency using a smart contract on the blockchain to the user. The user can store the Pyramidion Cryptocurrency of the present invention in any desired digital wallet and use the Pyramidion Cryptocurrency in any peer to peer (P-to-P) barter exchange. Subsequently, the method acquires prices of a predetermined plurality of cryptocurrencies of at least one cryptocurrency exchange (Step C). In this step, the method may acquire the prices of a predetermined number of cryptocurrencies traded on a specific exchange, or the prices of all cryptocurrencies traded on all existing exchanges. Then, the method assigns a barter credit to the Pyramidion cryptocurrency using the average of prices of the plurality of cryptocurrencies acquired (Step D). The method may calculate the average price of the cryptocurrencies acquired using simple arithmetic averaging, or any predetermined averaging method including, but not limited to, price weighted averaging, volume weighted averaging, etc. Further, the method relays the barter credit of the Pyramidion cryptocurrency to the corresponding PC device of a specific user account through the remote server (Step E). The method may repeat the pricing process in a predetermined time interval, including, but not limited to, every one minute, five minutes, 30 minutes, one hour, daily, etc.

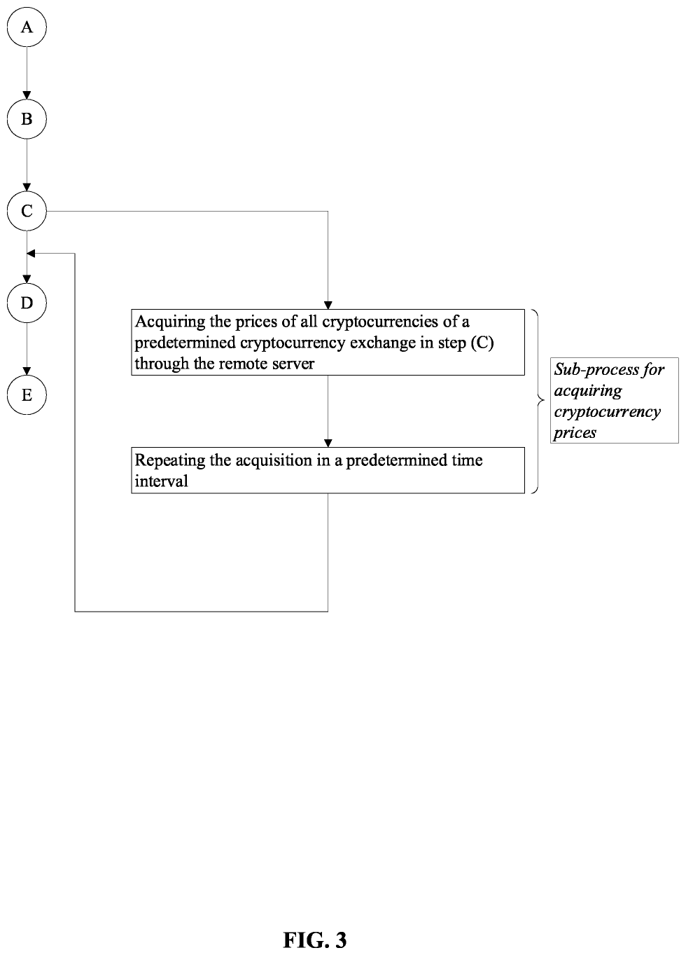

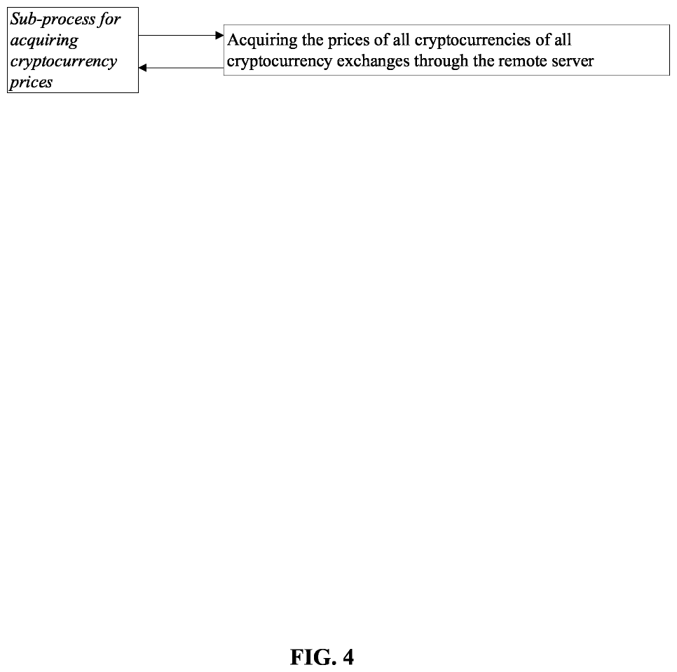

As can be seen in FIG. 3, the method of the present invention provides a sub-process for acquiring cryptocurrency prices. More specifically, the method acquires the prices of all cryptocurrencies of a predetermined cryptocurrency exchange in Step C through the remote server. As can be seen in FIG. 4, in some other embodiments of the present invention, the method may acquire the prices of all cryptocurrencies of all cryptocurrency exchanges through the remote server. Additionally, the method may repeat the acquisition in a predetermined time interval, including, but not limited to, every one minute, five minutes, 30 minutes, one hour, daily, etc.

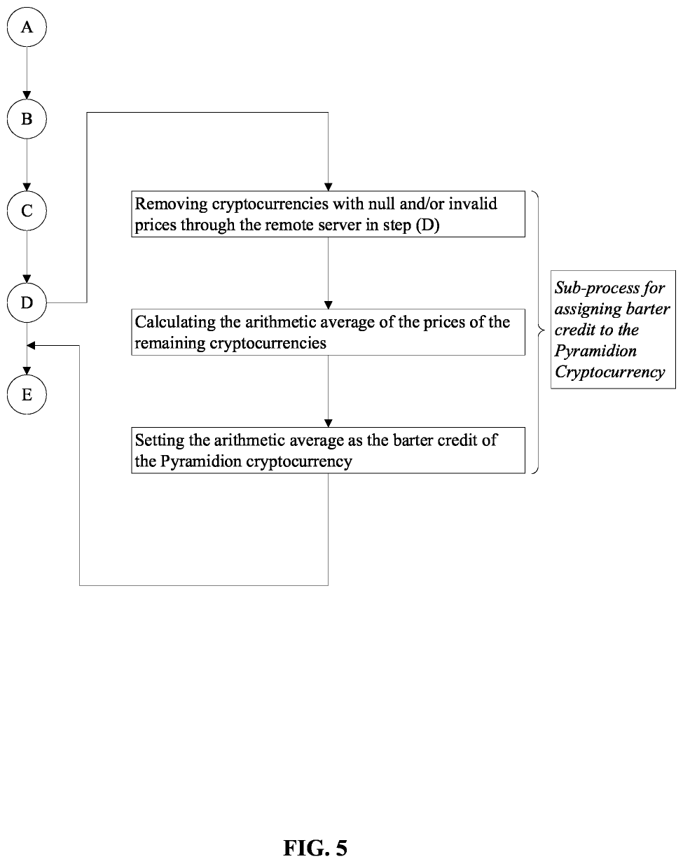

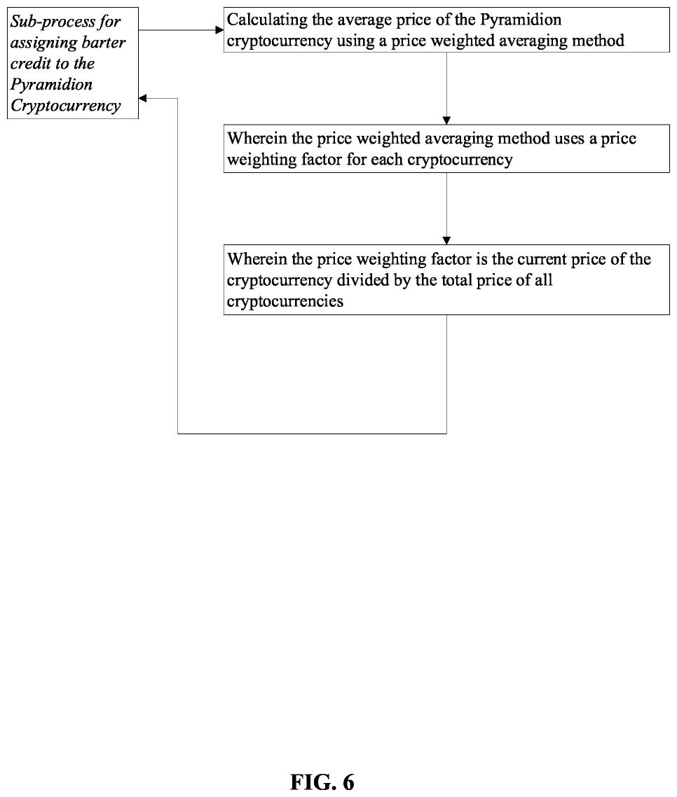

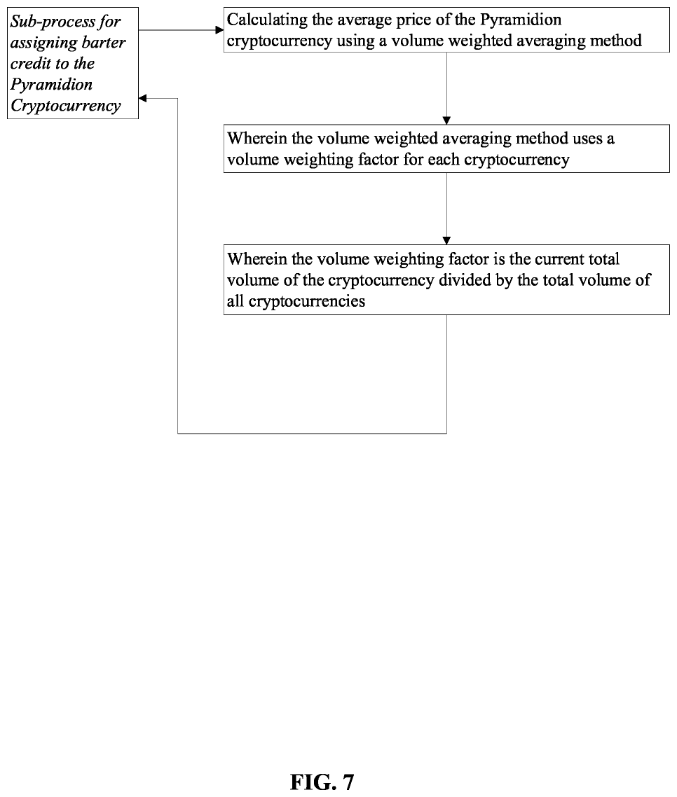

As can be seen in FIG. 5, the method of the present invention provides a sub-process for pricing the Pyramidion cryptocurrency. More specifically, the method removes the cryptocurrencies with null and/or invalid prices through the remote server in Step D through the remote server. Subsequently, the method calculates the arithmetic average of the prices of the remaining cryptocurrencies, and sets the arithmetic average as the price of the Pyramidion cryptocurrency of the present invention. As can be seen in FIG. 6, in some embodiments of the present invention, the method may calculate the average price of the Pyramidion cryptocurrency using a price weighted averaging method. Additionally, the price weighted averaging method uses a price weighting factor for each cryptocurrency, wherein the price weighting factor is the current price of the cryptocurrency divided by the total price of all cryptocurrencies. As can be seen in FIG. 7, in other embodiments of the present invention, the method may calculate the average price of all acquired cryptocurrencies using a volume weighted averaging method. The volume weighted averaging method uses a volume weighting factor for each cryptocurrency, wherein the volume weighting factor is the current total volume of the cryptocurrency divided by the total volume of all cryptocurrencies. The volume used in this averaging method is the actual trading volume for a cryptocurrency on a specific exchange.

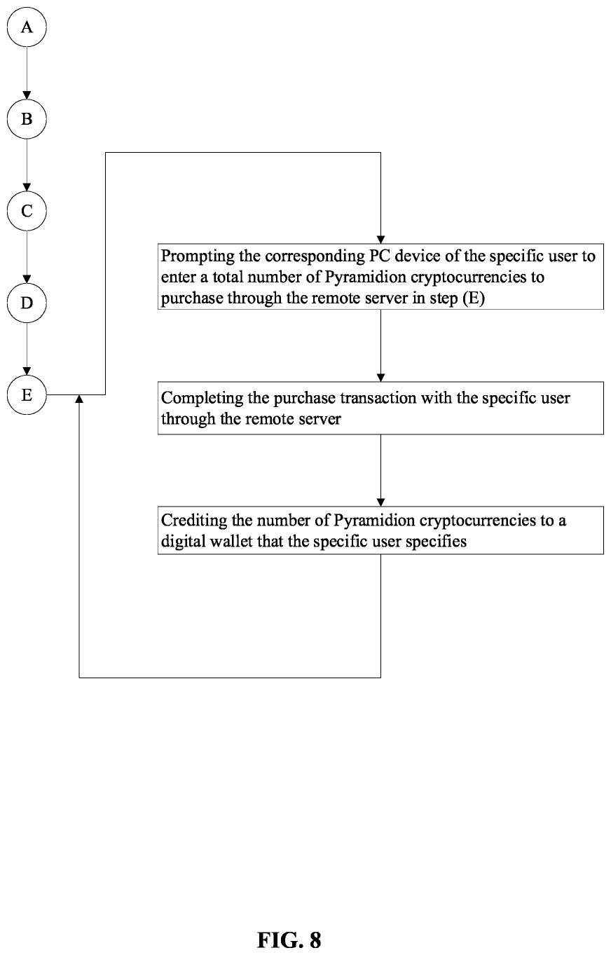

As can be seen in FIG. 8, the method of the present invention provides a sub-process for the user to purchase the Pyramidion cryptocurrency. More specifically, the method prompts the corresponding PC device of the specific user account to enter a total number of Pyramidion currencies to purchase through the remote server in Step E through the remote server. Subsequently, the method completes the purchase transaction with the specific user through the remote server, and credits the number of Pyramidion cryptocurrency to a digital wallet the specific user specifies. With the desired amount of Pyramidion currency in the user's digital wallet, the specific user may use the Pyramidion currency in any P-to-P barter exchange trades and/or transactions, thus, providing an efficient and convenient digital currency that comprises a fairly stable value.

### Overview:

The capstone or pyramidion is the highest block or mount of a structure. Pyramidion's namesake describes the concept of the barter credit methodology and the number of blocks in its construction. It is nicknamed “The Advocate Coin” due to the personality type of the concept's visionary inventor, and the nature of the token itself. Since PYRA is non-sovereign and represents a global economy it is envisioned to be the chosen asset for Mars at colonization. Pyramidion is created by a smart contract, powered by secure blockchain technology and has a total supply, but is not pegged to any single currency, technology, asset, real estate, resource or state. Pyramidion is a digital asset that captures equity from the exchange of goods or services where fiat or cash money is usually not involved. It becomes a way to barter backed by individuals—true public DeFi. Pyramidion's Barter Credit is derived and reaches a consensus from the totality of the cryptocurrency market. The concept came to mind in October of 2017 and would not have been viable without the explosion of digital asset creation. Like a pyramid, it takes many years and a lot of manpower to reach the construction phase of placing the Pyramidion.

Pyramidion is not an exchange-traded asset from Pyramidion Cryptocurrency LLC. The smart contract has no API (Application Programming Interface) which is a software intermediary that allows two applications to talk to each other. The smart contract does not interact with any virtual currency. The smart contract has no special instructions outside of keeping track of tokens and the Smart Contract Interaction Fee. Pyramidion has made it impossible to report pricing to an exchange, wallet, or platform for secondary sales or swaps while allowing customers to choose their wallet. A peer could place Pyramidion tokens on a DEX (a decentralized exchange, which is peer to peer) but there would be no pricing information or fund available to trade/swap or cash the token. A user can utilize the Pyramidion APP to calculate a number of tokens to send and wallet values.

Pyramidion shall not buyback its tokens. Pyramidion Cryptocurrency LLC shares no common interest with its purchasers/users. No ownership is granted in Pyramidion Cryptocurrency LLC with token purchases. No ownership is claimed by Pyramidion Cryptocurrency LLC for goods or services bartered with Pyramidion tokens. There is no dividend paid on the token. Pyramidion offers no goods or services for the token outside of the PYRA calculator and displaying the Barter Credit Excel Sheet for convenience. The funds used for purchasing Pyramidion tokens belong to Pyramidion Cryptocurrency LLC. A peer will have purchased a token with a universally agreed-upon Barter Credit. The project is developed and no manager, company, or centralized entity directs the development of the Pyramidion Cryptocurrency project. Pyramidion is sufficiently decentralized in operation, has a clear working product and the value of the Pyramidion token is tied to utility and not the expectation of profit—token barter credit appreciation does not equate to profit.

### Barter Credit Methodology:

Pyramidion utilizes Coingecko's API to populate a column in a Microsoft Excel spreadsheet. Almost every available asset traded on the exchanges is inserted into a column with its current price. All “null” values, errors, and assets trading below a penny are removed. A simple average is then calculated using all valid asset/cryptocurrency's prices. This agreed-upon Barter Credit is assigned to the Pyramidion tokens. The barter credits are equal to $1 for math and tax calculations.

The API utilizes pool-data and covers almost every asset on the exchanges. There is no need for real-time data with Pyramidion as it is not an exchange-traded asset, but still gives an accurate snapshot of the crypto space. The API automatically adds or removes digital assets in the spreadsheet. The Barter Value is auto-updating every five minutes. Wild swings in the barter credit are normal as assets move on the exchanges. This prevents “cashing out” with the tokens with liquidity providers that may use the tokens for their own use case and also can give clues as to what the barter credit may be in the future. For example, the range has been 220-380 for all of mid-2018 to present date with recent surges to 599.

### Problems/Solutions:

Compatibility: Why try to reinvent the wheel? This is why Pyramidion chose Ethereum. Ethereum is not just a cryptocurrency or store of value. It is a software platform. There is a very large development community with the Ethereum platform. Pyramidion can interact with many platforms as an ERC20 standard token. Pyramidion endorses Trustwallet for holding, sending, and receiving Pyramidion tokens. The logo has been attached for Trustwallet. Your security and seed phrases are your responsibility, keep them handwritten, and securely stored. It is not recommended to screenshot a Seed Phrase and save it to a phone or computer. Use a password and two-factor or two-step authentication if it is available. Pyramidion cannot recover passwords, seed phrases, or tokens for your wallet. Transactions are not reversible. Your platform must accept ERC20 tokens to receive Pyramidion. Do not use an exchange/hosted wallet like Coinbase to accept Pyramidion tokens or your Pyramidion tokens will be lost forever. If you like Coinbase they have a DApp wallet that can accept ERC20 tokens and you can connect and transfer coins directly from your Coinbase account to the Coinbase DApp wallet. MyEtherWallet (MEW) and MetaMask are also great options.
Ease of use/Accessibility: Pyramidion can be utilized by any ERC20 capable wallet. Add the PYRA App to your favorites in your browser or create a link on your cell phone. The APP is a custom calculator. For bartering a QR code can be scanned in person or sent in any platform's messaging service capable of sending a photo: FB messenger, Whatsapp, Slack, Telegram, Signal, Twitter, Skype, Zoom, Instagram, etc. Of course, a peer can simply send and receive Ethereum public key to receive the PYRA tokens. ENS Domain names are a recent development making it easier to type in a peer's user name instead of a long key. Example: Pyramidion.eth.
Decentralization, speedy transactions, and logging of transactions are native to Pyramidion because it is an ERC20 token. All transactions are publicly verified on Etherscan. Pyramidion does not operate its network, wallet, or an exchange and has no custom coding outside of the smart contract. There is no intermediary needed to utilize the token.
Whale Proof: An entity cannot dump Pyramidion en masse and lower the Barter Credit, nor buy up the supply of tokens and raise the Barter Credit. Manipulations in the barter credit are virtually eliminated, unless a person, group or country decided to buy up the entire cryptocurrency market and hold them to raise the Barter Credit.
Wash Trading: A third-party research group has reported top cryptocurrencies are wash traded between exchanges or bots and boosts trading volume artificially. Investors should be aware of this activity and not mistake it for use of an asset on a network. Pyramidion cannot be wash traded.
Security and Immutability: There are no exchanges to hack. The PYRA App has no download. No wallet keys or personal information is utilized in the PYRA App. All aspects of Pyramidion are easily understood and transparent. No single entity can dilute the barter value of Pyramidion. There will never be a hostile hard fork or highjacking of the Ethereum Network. There will be no governing body and operational rules are set in stone. Your security and tokens are literally in your hand.
Technical Debt: Why use Wix, Microsoft SharePoint, Excel, and other off-the-shelf systems to build the project? There is a term, “Technical Debt” which applies to companies that must upgrade their systems or hire vendors to keep up with development. Pyramidion utilizes WIX because they are a large company that can handle any amount of traffic and hosting is reasonable. Wix websites are WYSIWYG and easily managed by novice website builders. Microsoft Excel is used to compute the Barter Credit because of its reliability and there is no need for specialized code or upgrades. Anyone can verify Pyramidon's current barter credit with the API link used to populate the spreadsheet and applying the vetting rules. The Barter Credit sheet is hosted on Microsoft SharePoint. All of these methods are part of Pyramidion's set of core values for a reliable, secure, and decentralized product.
FOMO: The agreed-upon barter credit of the PYRA token is known before purchasing the token. There are 100 Billion tokens in the first release at One USD ($1). Pyramidion does not anticipate the need for the second release at $2. You are not missing out. No Fear. PYRA is for USE.

### Core Values:

Transparency, Integrity, Security, Legality, Self-Accountability

A decentralized and lean operation with the most efficient, secure, autonomous, and cost-effective procedures implemented. There will never be an IPO from Pyramidion Cryptocurrency LLC. Tokens are 100% owned by individuals.

### Pyramidion Tokenomics:

The bank makes a sound and is owned by the people. One trillion tokens assigned a Barter Credit. The simple average of the crypto space (with vetting rules) in USD assigned to the ERC20 token “Pyramidion” as the token's barter credit.

The asset list at the top of the page is the list of assets utilized to calculate Pyramidion's Barter Value, feel free to research them. It is auto-updated with assets as they are created and listed or delisted.

No further tokens will be created and no tokens will be burned. The token supply has been minted and awaits distribution from Pyramidion's Wallet.

The Transmitor holds all Pyramidion Tokens. No other entity holds PYRA tokens until sold. 100% of tokens are owned by users after purchase.

Tokens will be released in 100 Billion token increments in ascending pricing: The first 100 Billion at $1.00. The second 100 Billion at $2.00 The third 100 Billion at $3.00, and so on until one trillion tokens have been distributed. The 0.01% Smart Contract Interaction Fee in Pyramidion token is not used to calculate the release. The high supply of tokens is “just in case” and only released as needed.

All forms of payment will be listed in the token control dashboard.

The agreed-upon barter value or the number of barter credits in the Pyramidion token is known before purchase.

Pyramidion's Barter Credit is not derived from company performance or revenue flow. Pyramidion is not on a supply and demand algorithm and is not a stable coin, nor collateralized, and is taxed on its use.

Some projects utilize an index fund (ETF) for an index of cryptocurrencies or trade index tokens themselves on a maker/taker basis at exchanges. Pyramidion utilizes all assets reported by Coingecko to calculate a simple average. This agreed-upon Barter Value or the number of barter credits is assigned to the Pyramidion Token. Barter credits are equal to $1.00 for math calculations and IRS tax purposes.

Fees: Determine your favorite wallet's fees for sending an Ethereum token. The sender of the Pyramidion token supplies the gas. The receiver supplies a 0.01% Smart Contract Interaction Fee, which is calculated by the number of tokens sent multiplied by 0.0001. The Smart Contract Interaction Fee is in Pyramidion token and migrates back to Pyramidion's wallet. The Smart Contract Interaction Fee is reflected in the amount of Pyramidion received. The smart contract interaction fee is applied to every transaction from any platform. If you transfer tokens to a different wallet, the Smart Contract Interaction Fee still applies. This fee is to deter spamming the network.

Taxes: See Line 21 of the IRS Tax Form 1040A. Pyramidion is responsible for sales tax on token purchases. Currently, Pyramidion Cryptocurrency LLC is a tax pass-through and will be taxed as personal income for Damon Danner for token sales. There are no tax shelters and the taxes are treated as personal income to benefit the local economy. Both parties in trading goods or services with the token will be responsible for reporting the fair market value of goods or services as income on their tax returns. Use the Pyramidion App to email your receipts for record-keeping.

Barter Value of the Token Valid without Cashing at an Exchange/Converting to Virtual Currencies or Fiat:

The current Barter Value is made valid between peers through equity from the goods or services in the barter exchange and taxation by the IRS as income. It is Pyramidion's OPINION that this taxation makes the receiver of Pyramidion tokens collateralized/backed upon receipt (when a token is received for goods/services.) IRS tax law does not take this into account. The second use as a payment method could be argued because of double taxation on the same tokens. IRS tax law states that non-exchange-traded digital assets are taxed as income for the fair market value of goods and services at the time of the exchange. This is a new technology and tax law will continue to be refined for digital assets.

Donations/Nation Building/Community Finance: Pyramidion Cryptocurrency LLC assigns 5 Billion tokens for humanitarian purposes which will be counted towards the second release pricing of $2. The United States Government could authorize or purchase an amount to donate for a country to utilize, i.e., set aside an amount of money to back the tokens, the Pyramidion tokens eventually migrate to Pyramidion's wallet as sovereign systems are implemented.

Until a Pyramidion Token is utilized in a barter transaction between peers, a token transfer (donation or gift) has taken place, but no value is being transferred or moved on the blockchain, and no taxable event has occurred.

Pyramidion is a non-sovereign digital asset that captures equity in the exchange of goods and services without money. Pyramidion is not a traditional currency in its nature and unlike any other project in structure. It is backed or collateralized by the people that use it.

PYRA will never go to zero. If there is an operating Ethereum blockchain and for some unforeseen reason a barter credit consensus cannot be reached through a global index, the global user base of PYRA will vote on a standard barter credit per token. If this nuclear option were to happen it would be for reasons which would not allow for a normal life as we know it.

### Supported Use Case:

Peer to Peer informal barter: The IRS considers tokens property. Any transaction with Pyramidion is considered a barter exchange. Both parties must report the fair market value of goods or services in the barter exchange as income on their tax returns. The Pyramidion APP supplies all necessary functions to email a detailed barter exchange receipt. Choose your favorite wallet to send/receive PYRA. Please research barter exchange with the IRS. No taxes on 150 transactions per year or less, transactions for 1$ or less or certain foreign and exempt individuals. PYRA may be considered at face value outside of the United States. It was not built to operate as such and is a financial tool built from American financial policies. Apply your local laws for this unique asset.

Alternate Use Cases (Pyramidion does not Provide Services for these Use Cases):
Business Barter: For a business use case, any unused barter credits may be counted as a capital gain (this is an example from brokered business barter exchanges with barter credits on their account and may not apply for casual business use). Users must file a 1099B and Pyramidion does not provide this service.
International Barter Trade: Countries could barter goods without an intermediary or shipments of physical goods and still have an account or credit for barter exchange. All International laws apply, this goes without saying. Pyramidion moves on a public blockchain.
Corporate pre-built non-custodial utility: Easily move assets within an organization.
Donations: Donate PYRA to a good cause, no tax burden on the receiver as a gift.
Government use: The United States Government could authorize or purchase PYRA to donate to a cause. The government could asset back an amount of PYRA tokens for temporary economic relief. The Pyramidion would eventually get used up with use and returns to Pyramidion's wallet over time. The government can purchase tokens and utilize them as they see fit.
Video Game utility with real-world use. In-game prices could reflect the real world. Utilize your own point system and payout in PYRA tokens.
Rewards/Incentives: Purchase an amount of PYRA tokens and hand them out like merits. Have a prize for the token holders.
Asset-Backed digital asset: This may require you to register your tokens with the SEC and other legal implications. PYRA tokens become backed or collateralized when they are used in an exchange between peers.
Safely move asset-backed PYRA tokens without fear of losing actual assets. Keep your accounts safe and simply purchase more PYRA if tokens are lost—like a sacrificial token.
I.O.U. Token: Lend peer to peer with an agreement to buy-back PYRA tokens at barter credit value or whatever terms you choose.
Write up a simple agreement and reference a transaction hash. Reference the wallet addresses of the parties involved in the agreement. The PYRA App can send your receipts for payments. This is a legally binding agreement.
Vote Token: Have your citizen's send a token to yes and no wallets for line by line voting by citizens on issues.

### Glossary

1: Pyramidion—(singular) is the uppermost block of a structure and the name of the token.
2: Pyramidia—(plural) “I have 10 pyramidia.”
3: Block—a decimal unit of Pyramidion, as a “Satoshi” is to Bitcoin.
4: API—the acronym for Application Programming Interface, which is a software intermediary that allows two applications to communicate.
5: DAmbassador—Decentralized Ambassador, A non-contract voluntary ambassadorship over territory or holder of PYRA.
6: DAmbassador Guild—A number of PYRA holders/stakes/investors in a DOrganization. Example: 10,000 DAmbassadors staking PYRA tokens in equal shares of a DOrganization (Decentralized Organization).
7: DExcommunication—Forfeiture of assets due to fraud within a DAmbassador Guild

Although the invention has been explained in relation to its preferred embodiment, it is to be understood that many other possible modifications and variations can be made without departing from the spirit and scope of the invention as hereinafter claimed.

What is claimed is:

1. A method for facilitating a Pyramidion cryptocurrency used in barter exchanges comprising the steps of:
(A) providing a plurality of user accounts managed by at least one remote server, wherein each of the plurality of user accounts is associated with a corresponding personal computing (PC) device;
(B) providing the Pyramidion cryptocurrency on an online blockchain platform through the remote server;
(C) acquiring prices of a predetermined plurality of cryptocurrencies of at least one cryptocurrency exchange;
(D) assigning a barter credit to the Pyramidion cryptocurrency using the average of prices of the plurality of cryptocurrencies acquire;
(E) relaying the barter credit of the Pyramidion cryptocurrency to the corresponding PC device of a specific user account through the remote server.

2. The method for facilitating the Pyramidion cryptocurrency used in barter exchanges as claimed in claim 1 comprising the steps of:
acquiring the prices of all cryptocurrencies of a predetermined cryptocurrency exchange in step (C) through the remote server.

3. The method for facilitating the Pyramidion cryptocurrency used in barter exchanges as claimed in claim 2 comprising the steps of:
repeating the acquisition in a predetermined time interval.

4. The method for facilitating the Pyramidion cryptocurrency used in barter exchanges as claimed in claim 2 comprising the steps of:
acquiring the prices of all cryptocurrencies of all cryptocurrency exchanges through the remote server.

5. The method and system for providing statistical analysis of a medical treatment as claimed in claim 1 comprising the steps of:
removing cryptocurrencies with null and/or invalid prices through the remote server in step (D);
calculating the arithmetic average of the prices of the remaining cryptocurrencies; and
setting the arithmetic average price as the barter credit of the Pyramidion cryptocurrency.

6. The method and system for providing statistical analysis of a medical treatment as claimed in claim 5 comprising the steps of:
calculating the average price using a price weighted averaging method;
wherein the price weighted averaging method uses a price weighting factor for each cryptocurrency; and
wherein the price weighting factor is the current price of the cryptocurrency divided by the total price of all cryptocurrencies.

7. The method and system for providing statistical analysis of a medical treatment as claimed in claim 5 comprising the steps of:
calculating the average price using a volume weighted averaging method;
wherein the volume weighted averaging method uses a volume weighting factor for each cryptocurrency; and
wherein the volume weighting factor is the current total volume of the cryptocurrency divided by the total volume of all cryptocurrencies.

8. The method and system for providing statistical analysis of a medical treatment as claimed in claim 1 comprising the steps of:
prompting the corresponding PC device of the specific user to enter a total number of Pyramidion cryptocurrencies to purchase through the remote server in step (E);
completing the purchase transaction with the specific user through the remote server; and
crediting the number of Pyramidion cryptocurrencies to a digital wallet that the specific user specifies.
